(19) United States
(12) Patent Application Publication
(10) Pub. No.: US 2015/0345721 A1
(43) Pub. Date: Dec. 3, 2015

(54) LIGHT EMITTING DISPLAY BOARD AND DISPLAY PANEL RETAINING INTERFACE FOR A DOMESTIC APPLIANCE

(71) Applicants: BSH Home Appliances Corporation, Irvine, CA (US); BSH Bosch und Siemens Hausgeräte GmbH, Munich (DE)

(72) Inventors: Jason Hunter, New Bern, NC (US); George Savitz, New Bern, NC (US)

(73) Assignees: BSH Home Appliances Corporation, Irvine, CA (US); BSH Bosch und Siemens Hausgeräte GmbH, Munich (DE)

(21) Appl. No.: 14/291,561

(22) Filed: May 30, 2014

(51) Int. Cl. F21S 8/02; F21V 33/00

(52) U.S. Cl. CPC F21S 8/02; F21V 33/0044

(57) ABSTRACT

A domestic appliance is provided having an appliance body; a control panel mounted to the appliance body, the control panel having a front side visible to a user of the domestic appliance when the appliance is in an operating condition, and a back side facing the appliance body; a light box attached to the back side of the control panel, the light box having an opening that faces the back side of the control panel, a protrusion that protrudes in a direction away from the control panel and surrounds the opening; and a light emitting display board attached to the light box, the light emitting display board having a light source that emits light and directs the light toward the control panel. The light source is surrounded by the protrusion.

### FIELD OF THE INVENTION

The invention is directed to an apparatus and method related to containing and directing light emitted from a light emitting display board.

An example of an application for the invention is a light box attached to a back side of the control panel of a domestic appliance.

### BACKGROUND OF THE INVENTION

Some modern domestic kitchens include an appliance with a control panel that has some sort of backlit display. Such displays can be problematic in that light emitted from a light emitting display board or other light source can leak out of an intended location and cause an undesirable light that is visible to the user.

In some domestic appliances, a light emitting display board or other light source is attached to a main body of the domestic appliance that is located behind the control panel. The control panel is often removable for servicing or repair. In this arrangement, the light emitting display board or other light source is not attached to the control panel and, as a result, requires some sort of intermediary piece that bridges the gap between the light emitting display board or other light source and the back of the control panel. This intermediary piece is often required to be custom-made or adjusted in order to prevent light from leaking out of any unintended locations. However, even with a custom-made or individually adjusted intermediary piece, light often escapes and causes an undesirable light that is visible to the user.

Applicant recognized this problem and developed a solution as described herein.

### SUMMARY

The invention achieves the benefit of preventing undesirable light from being visible to a user of the domestic appliance. This benefit is achieved by providing a light box attached to the back side of the control panel such that no light can escape from between the light box and the control panel except for through designated openings in the light box. Further, a light emitting display board or other light source is attached to the light box instead of being attached to the supporting structure of the main body of the domestic appliance. By attaching the light emitting display board or other light source to the light box, which is, in turn, attached to the control panel, gaps between the three pieces can be greatly reduced or eliminated (reducing or eliminating undesirable light being visible to the user) while avoiding any custom fitting or adjusting.

Particular embodiments of the invention are directed to a domestic appliance comprising: an appliance body; a control panel mounted to the appliance body, the control panel having a front side visible to a user of the domestic appliance when the appliance is in an operating condition, and a back side facing the appliance body; a light box attached to the back side of the control panel, the light box having an opening that faces the back side of the control panel, and a protrusion that protrudes in a direction away from the control panel and surrounds the opening; and a light emitting display board attached to the light box, the light emitting display board having a light source that emits light and directs the light toward the control panel. The light source is surrounded by the protrusion.

Other embodiments of the invention are directed to a control panel assembly for a domestic appliance having an appliance body. The assembly comprises: a control panel configured to mount to the appliance body, the control panel having a front side visible to a user of the domestic appliance when the domestic appliance is in an operating condition, and a back side configured to face the appliance body; a light box attached to the back side of the control panel, the light box having an opening that faces the back side of the control panel, and a protrusion that protrudes in a direction away from the control panel and surrounds the opening; and a light emitting display board attached to the light box, the light emitting display board having a light source that emits light and directs the light toward the control panel. The light source is surrounded by the protrusion.

Other embodiments of the invention are directed to a method of attaching a light emitting display board to a control panel of a domestic appliance having an appliance body, the control panel having a front side visible to a user of the domestic appliance when the domestic appliance is in an operating condition, and a back side configured to face the appliance body. The method comprises: attaching a light box to the back side of the control panel, the light box having an opening that faces the back side of the control panel, and a protrusion that protrudes in a direction away from the control panel and surrounds the opening; and attaching the light emitting display board to the light box, the light emitting display board having a light source that emits light and directs the light toward the control panel. The light source is surrounded by the protrusion.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a partial perspective view of the back side of a control panel of a domestic appliance;

FIG. 2 is a perspective view of a light box for a domestic appliance;

FIG. 3 is a partial perspective view of the front side of a control panel of a domestic appliance;

FIG. 4 is a perspective view of an exemplary embodiment of the invention;

FIG. 5 is a perspective view of the exemplary embodiment shown in FIG. 4 attached to a control panel of a domestic appliance;

FIG. 6 is a perspective view of an exemplary embodiment of the invention;

FIG. 7 is a perspective view of an exemplary embodiment of the invention;

FIG. 8 is a perspective view of an exemplary embodiment of the invention; and

FIG. 9 is a chart showing an exemplary method in accordance with embodiments of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

As explained above, embodiments of the invention provide a solution to the problem of undesirable light generated by a light emitting display board or other light source being visible to a user of the domestic appliance through the control panel. In some domestic appliances, the control panel is glass, in other domestic appliances, the control panel is molded acrylic with in-molded text. Especially in the case of molded acrylic with in-molded text, pointed light such as light emitting diodes are used.

In the following description, the example of a light emitting display board with light emitting diodes will be used as a light source behind the control panel. It is noted however that other light sources can also be used, whether or not they are mounted to a light emitting display board.

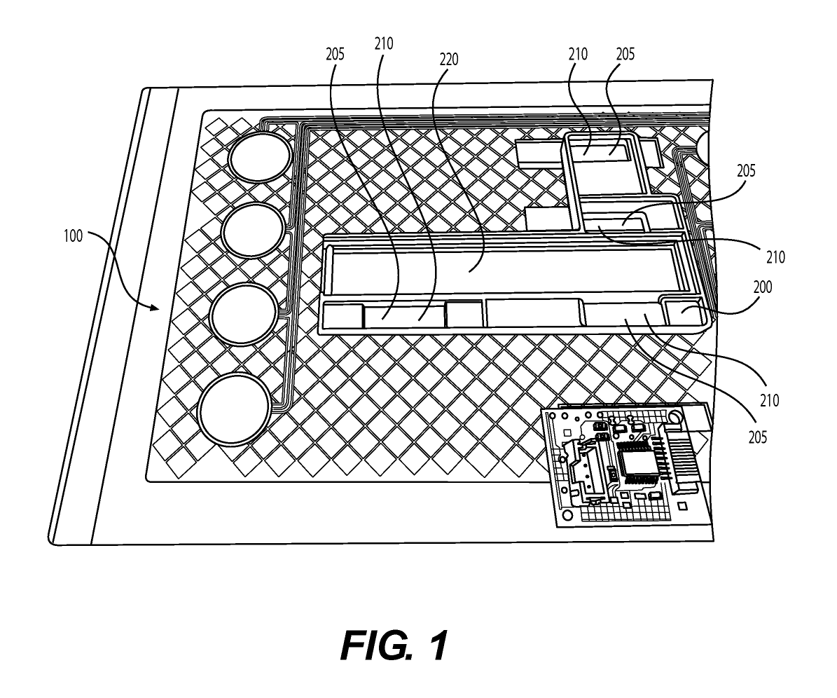

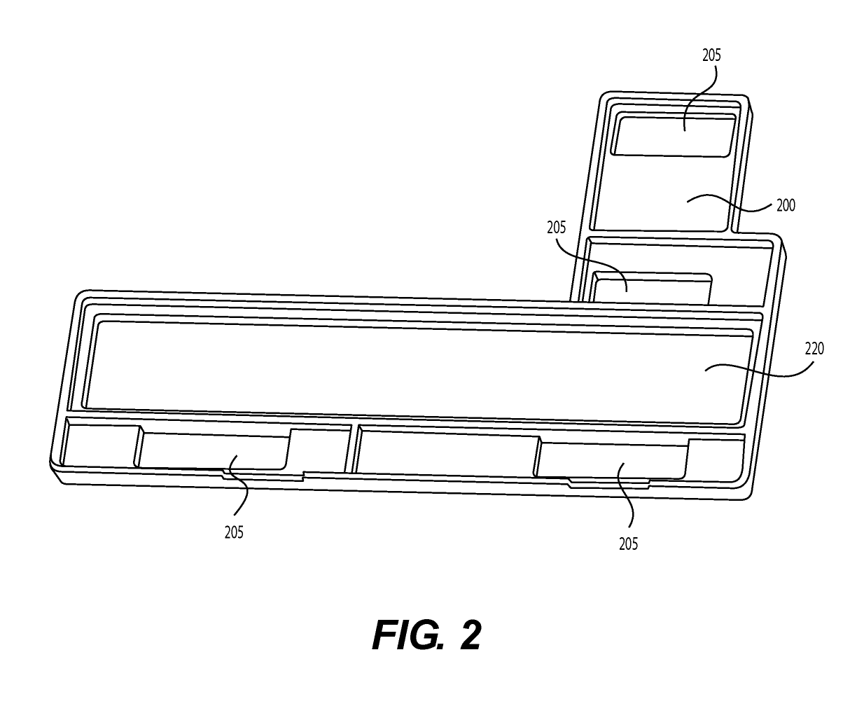

FIG. 1 shows an example of a control panel 100 that is part of a domestic appliance. FIG. 1 is a view of the back side of control panel 100, which is the side that faces away from the user and toward a main body of the domestic appliance. Examples of various circuits, displays and openings are seen in the figure. Also shown in FIG. 1 (and shown by itself in FIG. 2) is a light box 200 that is mounted to the back side of control panel 100. In this example, light box 200 has one large opening 220 and several smaller openings 205 through which light generated by one or more light sources located behind control panel 100 radiates through light box 200. In this example, control panel 100 has at the locations of openings 205 a diffusing agent 210 that diffuses light from the one or more light sources. Regardless of the nature of the one or more light sources and whether a diffusing agent is used, the purpose of light box 200 is to channel the light to the appropriate opening and prevent it from being seen through any of the other openings.

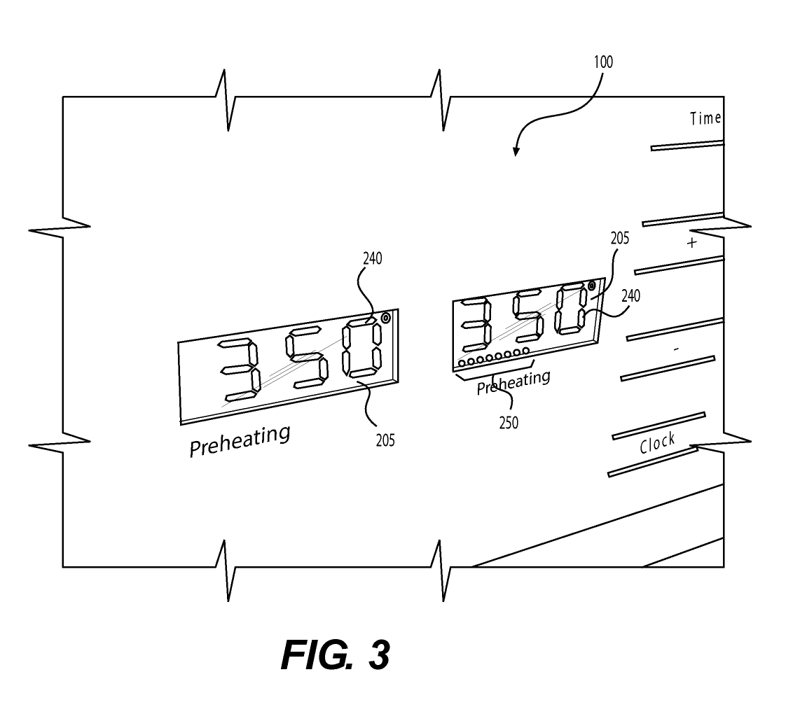

In the arrangement shown in FIG. 1, when the light emitting display board or other light source is mounted to the support structure of the main body of the domestic appliance, the problem of light being seen through an opening other than the desired opening can result. An example of this is shown in FIG. 3 where undesired light, represented by point sources 250, can be seen through the opening for display 240 in control panel 100.

To prevent, or at least reduce, the above described undesirable light, embodiments of the invention provide for the light emitting display board containing the light source or sources to be attached directly to the light box so that proper spacing is automatically maintained.

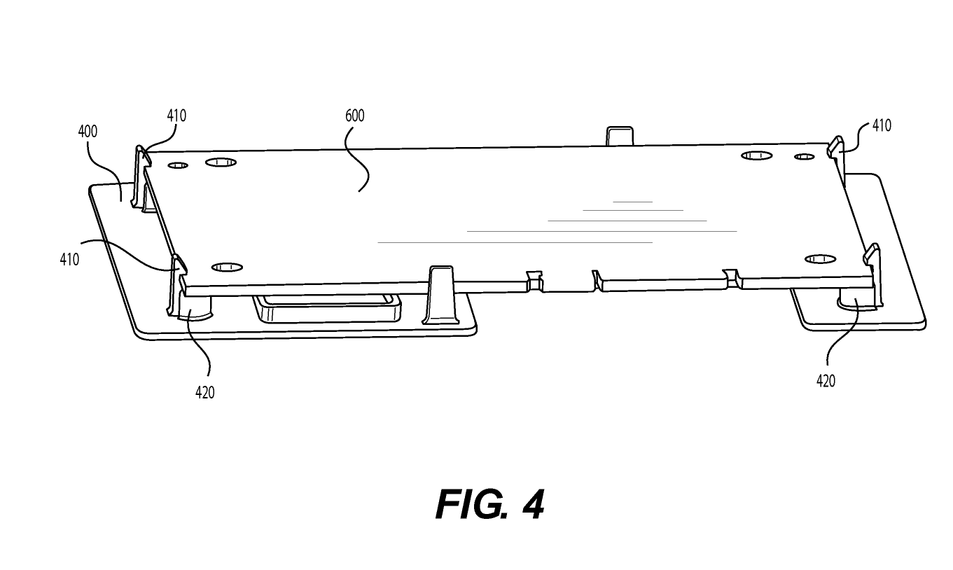

FIG. 4 shows an example of a light box 400 having a number of supports 420 and clips 410 which hold a light emitting display board 600 at precisely the desired position relative to light box 400. In this example, light emitting display board 600 includes a number of light emitting diodes that provide the light needed to illuminate the various display areas of the control panel visible to the user.

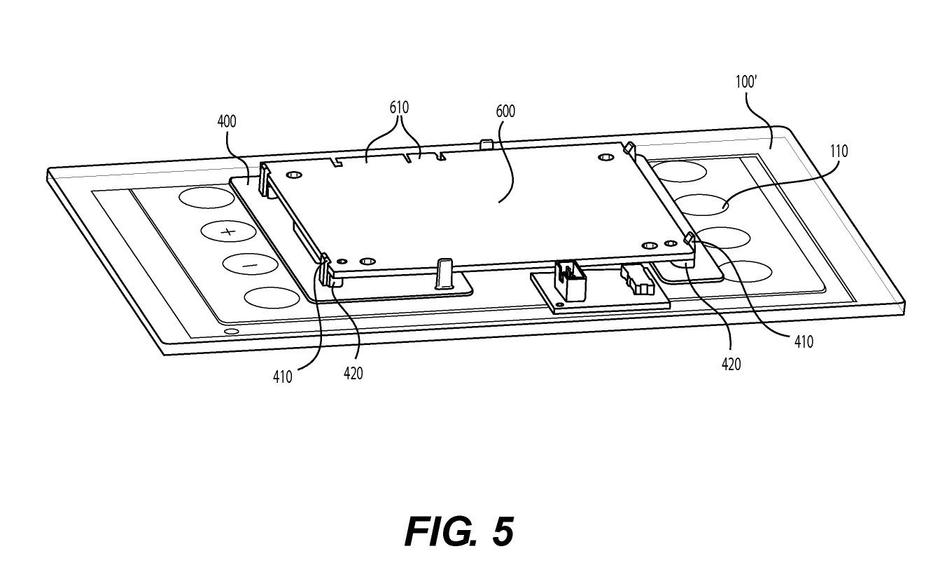

FIG. 5 shows light box 400 attached to a back side of control panel 100′. In this example, light box 400 is glued or taped to the back of control panel 100′ such that light box 400 is permanently affixed to control panel 100′. In this configuration, when control panel 100′ is removed from the main body of the domestic appliance for service or repair, light emitting display board 600 is also moved relative to the main body of the domestic appliance. As a result, light emitting display board 600 is electrically connected to the main body of the domestic appliance by some sort of wire or ribbon. FIG. 5 shows connection points 610 as examples of connectors for such wires or ribbons. When control panel 100′ is removed for service or repair, the wires or ribbons can be easily disconnected from connection points 610 to allow complete removal of control panel 100′. Also, in this example, light emitting display board 600 can be removed from light box 400 by carefully bending clips 410 outward.

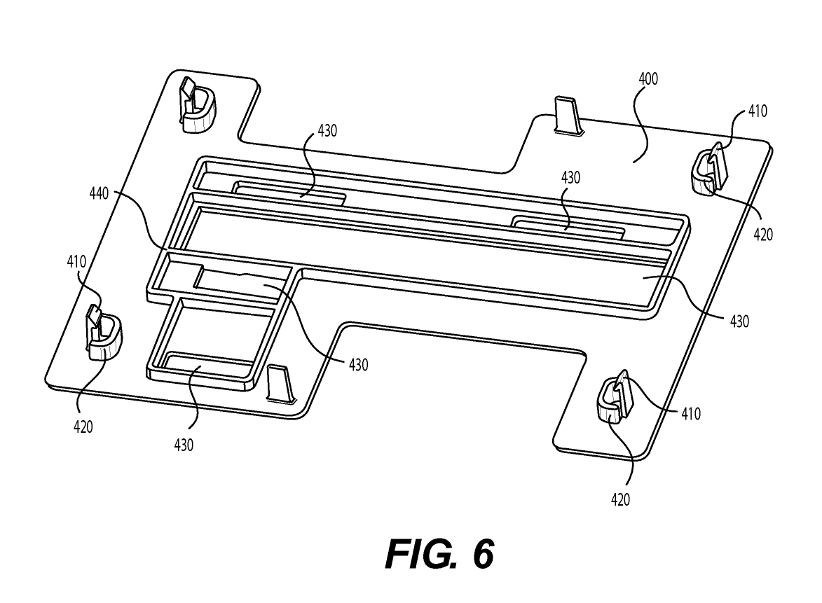

FIG. 6 shows light box 400 without light emitting display board 600 in place. This figure shows that light box 400, in this example, has a protrusion 440 that separates a plurality of openings 430 in light box 400. Protrusion 440 prevents or at least greatly limits light intended for one opening 430 from exiting any other opening 430. In some examples, the light emitting diodes extend away from light emitting display board 600 such that they extend into the separate compartments formed by protrusion 440.

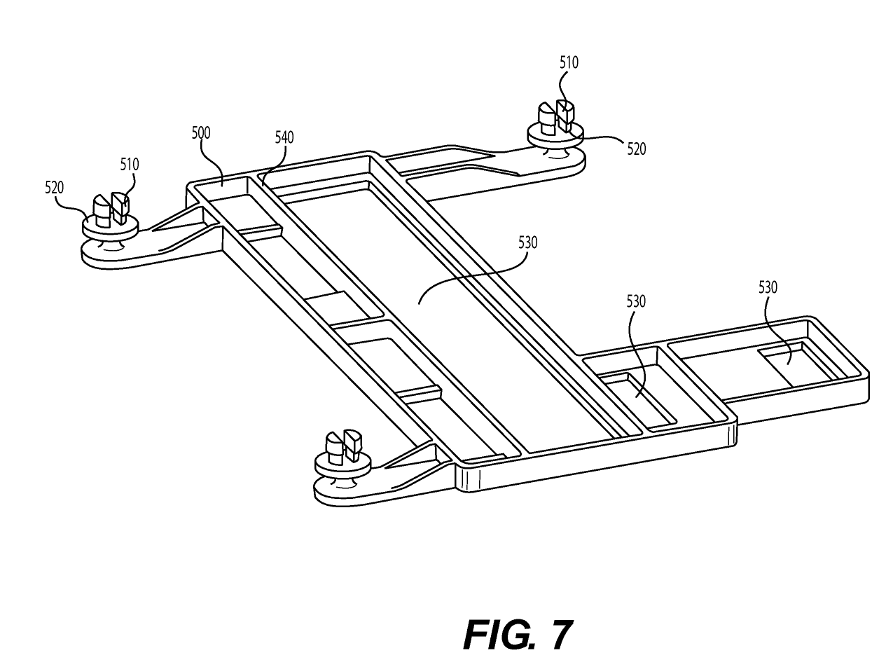

FIG. 7 shows another example of a light box in accordance with the invention. FIG. 7 shows a light box 500 having a protrusion 540 and various openings 530. In this embodiment, the light emitting display board has a number of holes that line up with clips 510 that extend from supports 520. The light emitting display board is attached to light box 500 by pressing it down onto light box 500 so that clips 510 extend through the holes in light emitting display board 600 and spring outwardly to secure light emitting display board 600 in place. As in the embodiment shown in FIG. 6, the light emitting display board can be removed from light box 500 by bending the clips and pulling the print circuit board away from light box 500.

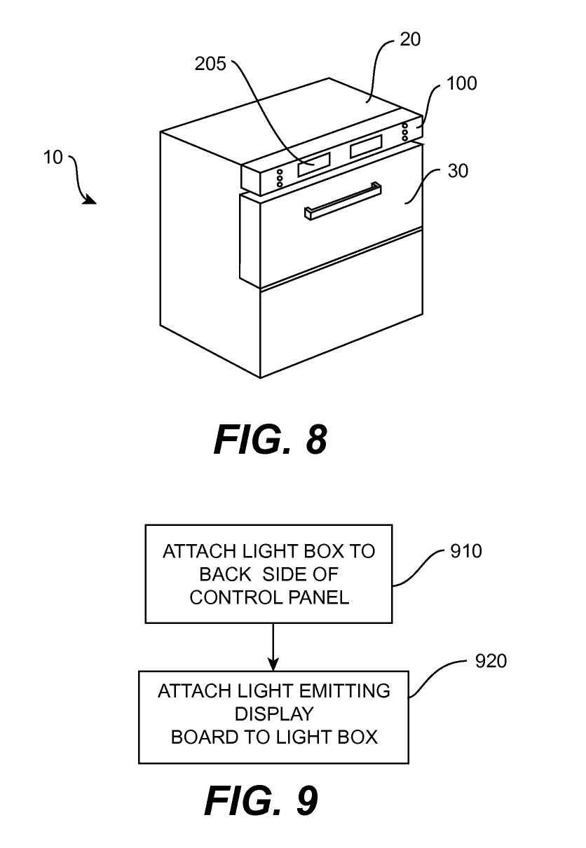

FIG. 8 shows an example of a domestic appliance 10 having a main body 20 and a door 30. This figure shows an example of control panel 100, 100′ in place on domestic appliance 10.

FIG. 9 shows an example of a method in accordance with the invention. In step 910, a light box is attached to the back side of a control panel. In step 920 a light emitting display board is attached to the light box. As described above, the light box can be permanently affixed to the back side of the control panel with glue, tape, or other fixing method. In embodiments, the light emitting display board is removably attached to the light box so that it can be removed for service or replacement.

As can be seen in the above exemplary embodiments, the invention provides a solution to the problem of undesirable light on a control panel being seen by a user of a domestic appliance. While providing the solution, embodiments of the invention are simple to produce and provide the desired tolerances without the need for custom-made or custom adjusted elements. As a result, embodiments of the invention provide a simple and inexpensive solution to this problem.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. A domestic appliance comprising:
an appliance body;
a control panel mounted to the appliance body, the control panel having a front side visible to a user of the domestic appliance when the appliance is in an operating condition, and a back side facing the appliance body;
a light box attached to the back side of the control panel, the light box having
an opening that faces the back side of the control panel, and
a protrusion that protrudes in a direction away from the control panel and surrounds the opening; and
a light emitting display board attached to the light box, the light emitting display board having a light source that emits light and directs the light toward the control panel,
wherein the light source is surrounded by the protrusion.

2. The appliance of claim 1, wherein the light box is attached directly to the back side of the control panel.

3. The appliance of claim 2, wherein the light emitting display board is removably attached to the light box.

4. The appliance of claim 3, wherein the opening aligns with a window in the control panel such that the light emitted from the light source is visible from a front side of the control panel through the window.

5. The appliance of claim 4, wherein the protrusion contains the light emitted from the light source such that the light emitted from the light source exits the light box only through the opening.

6. The appliance of claim 4, wherein the window is covered by a diffusing agent that diffuses the light emitted by the light source.

7. The appliance of claim 1, wherein the light box is permanently fixed directly to the back side of the control panel such that the light box cannot be removed from the control panel without damaging the light box and/or the control panel.

8. A control panel assembly for a domestic appliance having an appliance body, the assembly comprising:
a control panel configured to mount to the appliance body, the control panel having a front side visible to a user of the domestic appliance when the domestic appliance is in an operating condition, and a back side configured to face the appliance body;
a light box attached to the back side of the control panel, the light box having
an opening that faces the back side of the control panel, and
a protrusion that protrudes in a direction away from the control panel and surrounds the opening; and
a light emitting display board attached to the light box, the light emitting display board having a light source that emits light and directs the light toward the control panel,
wherein the light source is surrounded by the protrusion.

9. The assembly of claim 8, wherein the light box is attached directly to the back side of the control panel.

10. The assembly of claim 9, wherein the light emitting display board is removably attached to the light box.

11. The assembly of claim 10, wherein the opening aligns with a window in the control panel such that the light emitted from the light source is visible from a front side of the control panel through the window.

12. The assembly of claim 11, wherein the protrusion contains the light emitted from the light source such that the light emitted from the light source exits the light box only through the opening.

13. The assembly of claim 11, wherein the window is covered by a diffusing agent that diffuses the light emitted by the light source.

14. The assembly of claim 8, wherein the light box is permanently fixed directly to the back side of the control panel such that the light box cannot be removed from the control panel without damaging the light box and/or the control panel.

15. A method of attaching a light emitting display board to a control panel of a domestic appliance having an appliance body, the control panel having a front side visible to a user of the domestic appliance when the domestic appliance is in an operating condition, and a back side configured to face the appliance body, the method comprising:
attaching a light box to the back side of the control panel, the light box having
an opening that faces the back side of the control panel, and
a protrusion that protrudes in a direction away from the control panel and surrounds the opening; and
attaching the light emitting display board to the light box, the light emitting display board having a light source that emits light and directs the light toward the control panel,
wherein the light source is surrounded by the protrusion.

16. The method of claim 15, wherein the light box is attached directly to the back side of the control panel.

17. The method of claim 16, wherein the light emitting display board is removably attached to the light box.

18. The method of claim 17, wherein the opening aligns with a window in the control panel such that the light emitted from the light source is visible from a front side of the control panel through the window.

19. The method of claim 18, wherein the protrusion contains the light emitted from the light source such that the light emitted from the light source exits the light box only through the opening.

20. The method of claim 18, wherein the window is covered by a diffusing agent that diffuses the light emitted by the light source.

21. The method of claim 15, wherein the light box is permanently fixed directly to the back side of the control panel such that the light box cannot be removed from the control panel without damaging the light box and/or the control panel.
